(19) United States
(12) Patent Application Publication
(10) Pub. No.: US 2026/0253777 A1
(43) Pub. Date: Aug. 27, 2026

(54) ELECTROMAGNETIC ACTUATOR

(71) Applicant: CANON KABUSHIKI KAISHA, Tokyo (JP)

(72) Inventors: YUICHI FUJITA, Tochigi (JP); NORIHIRO SAKURAKAWA, Tochigi (JP)

(21) Appl. No.: 19/546,055

(22) Filed: Feb. 20, 2026

(30) Foreign Application Priority Data
Feb. 25, 2025 (JP) 2025-028186

(51) Int. Cl. H01F 7/08; H01F 7/16

(52) U.S. Cl. CPC H01F 7/081; H01F 7/16

(57) ABSTRACT

An electromagnetic actuator includes a stator extending in a first direction, and a mover capable of moving in the first direction. The mover has a yoke, a housing, bolts, a main pole magnet disposed with a magnetic pole oriented in a direction perpendicular to the yoke, and an interpole magnet disposed with a magnetic pole oriented in a direction not perpendicular to the yoke. The main pole magnet and the interpole magnet are fixed to the yoke with an adhesive, the yoke and the housing are fastened using the bolts, and the number of the bolts on a projected area of the main pole magnet is less than the number of the bolts on a projected area of the interpole magnet.

### BACKGROUND

### Field of the Technology

The present disclosure relates to an electromagnetic actuator constituted of a stator and a mover.

### DESCRIPTION OF THE RELATED ART

In the related art, electromagnetic actuators performing linear motion have been used to drive devices requiring precise positioning, such as exposure devices used in manufacturing semiconductor devices, machine tools, and railway systems. For example, the electromagnetic actuator discussed in Japanese Unexamined Patent Application, First Publication No. 2003-116260 includes a stator having a fixed coil, and a mover having a movable magnet. A magnetic flux is generated by causing a current to flow in the coil, and a drive force is generated in the movable magnet due to an interaction with a magnetic field of the magnet, thereby enabling the mover to move.

In recent years, there has been a demand for higher driving speeds in order to improve the productivity of devices. To achieve high-speed driving, the electromagnetic actuator needs to generate a higher thrust, and the structure of a mover generating a high thrust is subjected to a high load corresponding to the generated thrust.

For this reason, the load on the mover may concentrate stress around bolts provided between components, and the stress will propagate to an adhesive fixing the magnet, which may result in peeling of an adhesive portion.

### SUMMARY

An aspect of the present disclosure provides an electromagnetic actuator that includes a stator extending in a first direction, and a mover configured to move in the first direction. The mover includes a yoke, a housing, a main pole magnet and an interpole magnet. The main pole magnet is configured to orient a magnetic pole in a direction perpendicular to the yoke. The interpole magnet is configured to orient a magnetic pole in a direction not perpendicular to the yoke. The main pole magnet and the interpole magnet are fixed to the yoke with an adhesive. The yoke and the housing are fastened using a plurality of bolts. A first group of bolts of the plurality of bolt is provided on a projected area of the main pole magnet. A second group of bolts of the plurality of bolts is provided on a projected area of the interpole magnet. The first group includes fewer bolts than the second group.

Features of the present disclosure will become apparent from the following description of embodiments with reference to the attached drawings.

### BRIEF DESCRIPTION OF THE DRAWINGS

FIGS. 1A and 1B are views showing an example of a configuration of an electromagnetic actuator according to a first embodiment of the present disclosure.

FIG. 2 is a view showing an example of a configuration of a part of a mover according to the first embodiment.

FIG. 3 is a view showing an example of a configuration of the electromagnetic actuator according to a second embodiment.

FIG. 4 is a view showing an example of a configuration of the electromagnetic actuator according to a the third embodiment.

FIGS. 5A and 5B are views showing another example of a configuration of the electromagnetic actuator according to a fourth embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements. For conciseness, duplicate description is incorporated by reference or simplified.

### First Embodiment

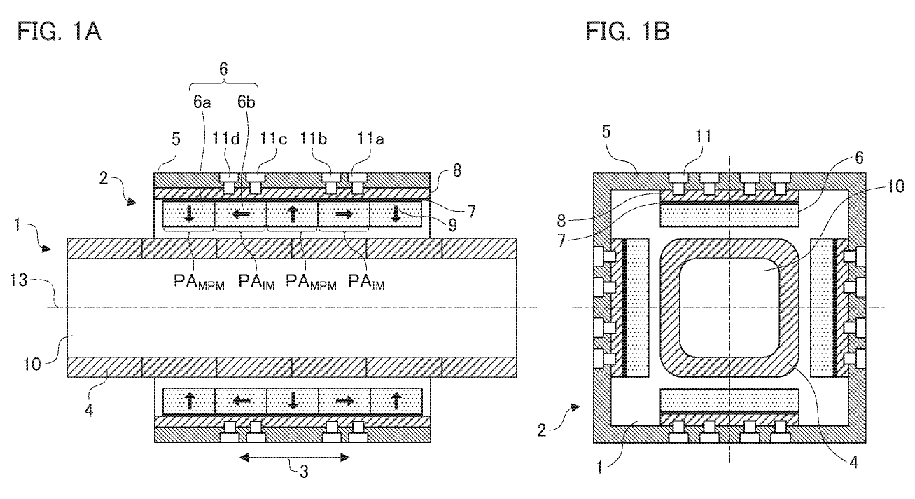

FIGS. 1A and 1B are views showing an example of a configuration of an electromagnetic actuator according to the first embodiment of the present disclosure. FIG. 1A is a cross-sectional view along a plane including an axis 13, and FIG. 1B is a cross-sectional view along a plane perpendicular to the axis 13.

As shown in FIGS. 1A and 1B, the electromagnetic actuator according to the present embodiment has a stator 1 and a mover 2. The stator 1 has a columnar shape extending in a first (longitudinal) direction 3 and is constituted of a support member 10 along the axis center, and a plurality of coils 4 disposed on the outer surface of the support member 10. The mover 2 can move in the first direction 3.

An insulating member or a yoke, or both, may be disposed between the support member 10 and the coils 4. The support member 10 functions as a base for supporting the coils 4. To prevent a temperature rise of the coils, a coil cooling passage may be provided inside the support member 10.

For example, the coil cooling passage allowing a cooling medium to flow therethrough may be provided inside or on a surface of a housing 5 of the mover 2. Thus, a temperature rise of the electromagnetic actuator may be curbed by providing a cooling passage in at least one of the stator 1 and the mover 2, with cooling medium flowing therethrough.

The mover 2 has a hollow shape surrounding the outer circumferential portion of the stator 1 in a plane orthogonal to the first direction 3 in a non-contact manner and penetrated in the first direction 3. As shown in FIG. 1B, a plurality of magnets 6 are arranged in two opposing pairs on the inner surface of the mover 2.

The plurality of magnets 6 includes an interpole magnet 6b magnetized in the direction of the axis 13 and a main pole magnet 6a magnetized in a direction orthogonal to the axis 13, as indicated by orientation 9 of the magnetic poles, and are arranged to generate an alternating magnetic field on the inner surface of the mover.

In addition, in the present embodiment, the plurality of magnets 6 are in a Halbach array generating a substantially sinusoidal magnetic field for one cycle. As shown in FIG. 1B, in the present embodiment, the stator 1 and the mover 2 have a substantially rectangular cross-sectional shape, but are not so limited. For example, a circular or elliptical may be used, with the cross-sectional shape not being limited to the shape illustrated in FIG. 1B.

A part or the entire surface of each magnet 6 is held by a yoke 8 with an adhesive layer 7 therebetween, and the yoke 8 is held by the housing 5 and bolts 11. That is, the main pole magnet 6a and the interpole magnet 6b are fixed to the yoke 8 with an adhesive, and the yoke 8 and the housing 5 are fastened using the bolts 11.

In this manner, the mover 2 according to the present embodiment has the yoke 8, the housing 5, the bolts 11, the main pole magnet 6a disposed with its magnetic pole oriented in a direction perpendicular to the yoke 8, and the interpole magnet 6b disposed with its magnetic pole oriented in a direction not perpendicular to the yoke 8. When a cooling passage allowing a cooling medium to flow therethrough is provided inside or on a surface of the housing 5, the bolts 11 are disposed at positions where they avoid the cooling passage.

The plurality of coils 4 have a plurality of phases (in this example, two phases A and B). In addition, in a method for driving a linear motor according to the present embodiment, sine waves are supplied to the plurality of coils 4, and control is performed such that the current and the magnetic flux are orthogonal to each other. In addition, generation of heat is reduced by switching the coils such that sine waves are supplied only to those coils of the plurality of coils 4 opposing the plurality of magnets 6.

In the electromagnetic actuator according to the present embodiment, in order to efficiently utilize the magnetic fields generated by the coils 4 as a drive force, the gap between the coils 4 and the magnets 6 is reduced in size as much as possible.

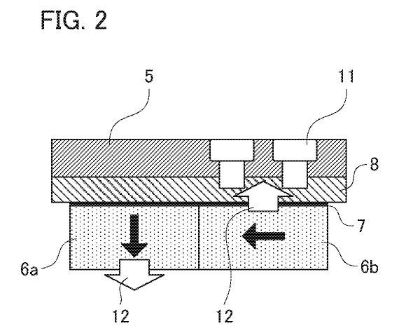

FIG. 2 is a view showing an example of a configuration of a part of the mover 2 according to the first embodiment. As described above, the magnets 6 are each constituted of the interpole magnet 6b magnetized in the direction of the axis 13, and the main pole magnet 6a magnetized in a direction orthogonal to the axis 13 in a Halbach array generating a substantially sinusoidal magnetic field.

At this time, orientations 12 of forces acting on respective magnets 6 due to the magnetic forces of the coils 4 generate a peeling force in the main pole magnet 6a with respect to the adhesive layer 7 in a direction separating the main pole magnet 6a from the yoke 8. In addition, in the interpole magnet 6b, a compressive force is generated on the adhesive layer 7 in a direction of attraction with respect to the yoke 8. That is, when the adhesive layer 7 is damaged, the main pole magnet 6a is more likely to peel and separate from the adhesive layer 7, than the interpole magnet 6b.

On the other hand, when a thrust is generated by energizing the coils 4, the housing 5 deforms due to an inertial force generated between the housing 5 and a connected drive target, thereby generating stress. At this time, the inertial force causes deformation at an end portion of the mover 2 in the direction of the axis 13.

The generated stress propagates to the bolts 11 through the housing 5, and the stress is concentrated around the bolts 11 of the yoke 8. Thus, the adhesive layer 7 may break in the part of the adhesive layer 7 that is closer to the bolts 11 and the adhesion may peel off.

Hence, in the present embodiment, the bolts 11 (11a, 11b, 11c, and 11d) for fastening the housing 5 and the yoke 8 are disposed in a projected area (PA_{IM}) of the interpole magnet 6b, and are not disposed in a projected area (PA_{MPM}) of the main pole magnet 6a provided at the end portion of the mover 2 in the direction of the axis 13.

When the mover 2 deforms due to the inertial force and stress that is generated in the mover 2, the bolts 11 are disposed at locations where deformation of the mover 2 is reduced, and the bolts 11 are not disposed at locations where deformation is larger.

Thus, even if a force acts on the magnet 6 in an adhesion peeling direction, i.e. the first (longitudinal) direction 3, concentrated stress generated around the bolts 11 is not generated near the main pole magnet 6a and separation of the magnet 6 is reduced.

### Second Embodiment

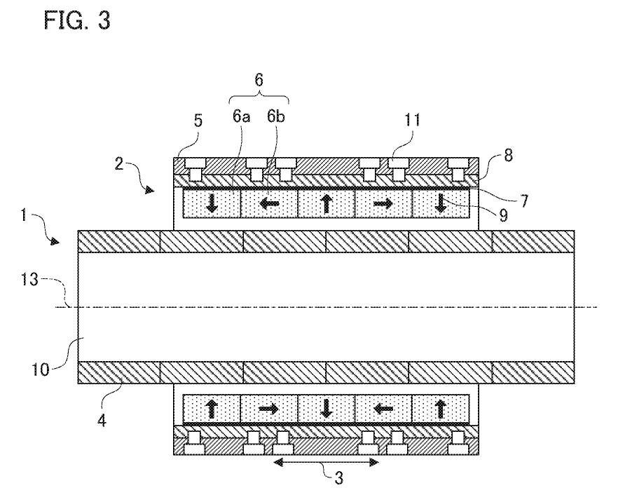

FIG. 3 is a view showing an example of a configuration of the electromagnetic actuator according to the second embodiment. In the mover 2 according to the second embodiment, the bolts 11 for fastening the yoke 8 and the housing 5 are disposed not only in the projected area of the interpole magnet 6b but also in the projected area of the main pole magnet 6a.

However, fewer bolts 11 are disposed in the projected area of the main pole magnet 6a than in the projected area of the interpole magnet 6b. That is, the number of bolts 11 in the projected area of the main pole magnet 6a is less than the number of bolts 11 in the projected area of the interpole magnet 6b.

The number of bolts 11 in the projected area of the main pole magnet 6a disposed at the end portion of the mover 2 is set to be less than the number of bolts 11 in the projected area of the interpole magnet 6b disposed at locations, other than the end portion of the mover 2. In the second embodiment, a lesser number of bolts 11 disposed in the projected area of the main pole magnet includes the case where no bolts are provided in the projected area of the main pole magnet, as in the first embodiment.

The number of bolts 11 fastening the yoke 8 to the housing 5 ensures sufficient fastening force to hold the housing 5 to the yoke 8. Thus, the present embodiment is effective when space limitations preclude all of the bolts 11 from being disposed in the projected area of the interpole magnet 6b.

In the present embodiment, the number of bolts 11 disposed in the projected area of the main pole magnet 6a is less than the number of bolts 11 disposed in the projected area of the interpole magnet 6b. Thus, when a force acts on the magnet 6 in the adhesion peeling direction, concentrated stress generated around the bolts 11 is not generated near the main pole magnet 6a, which is more likely to separate from the adhesive layer 7 than the interpole magnet 6b,separation of the magnet 6 is prevented.

The plurality of bolts in the projected area of the main pole magnet 6a may be disposed such that spacings therebetween are wider than the spacings between the plurality of bolts in the projected area of the interpole magnet 6b. In addition, for example, when the plurality of bolts 11 (three or more) are arranged in the direction along the axis 13 in the projected area of the main pole magnet 6a, the spacings between the three or more bolts 11 may differ from each other.

For example, two bolts 11 on the end portion side of the mover 2 may be disposed such that the spacing therebetween is wider than the spacings between the remaining bolts 11. That is, in the projected area of the main pole magnet 6a, the spacing between the bolts 11 on the end portion side of the mover 2 may be wider than the spacings between the remaining bolts 11. Accordingly, concentrated stress generated around the bolts 11 on the end portion side is reduced.

In the present embodiment, the bolts 11 are not disposed in the projected area of the main pole magnet 6a, other than the end portion of the mover 2 in the first direction 3 (i.e. axial direction). This prevents separation of the main pole magnet 6a by reducing concentrated stress in the main pole magnet 6a, other than the end portion of the mover 2 in the axial direction.

To further increase the fastening force to hold the magnets 6 and the yoke 8, a number of bolts disposed in the projected area of the main pole magnet 6a, other than the end portion of the mover 2 in the axial direction, is less than the number of bolts 11 disposed in the projected area of the interpole magnet 6b.

FIG. 3 shows the bolts 11 disposed on the surface of the housing 5 arranged in the direction of the axis 13 disposed in a direction perpendicular to the axis 13 on the surface of the housing 5. Even in this case, the number of bolts 11 disposed in the projected area of the main pole magnet 6a is less than the number of bolts 11 disposed in the projected area of the interpole magnet 6b.

The disposition pattern of the plurality of bolts 11 disposed in the projected area of the main pole magnet 6a on the surface of the housing 5 may differ from the disposition pattern of the plurality of bolts 11 disposed in the projected area of the interpole magnet 6b. A two-dimensional disposition pattern is illustrated as an example, with predetermined spacings between the plurality of bolts 11 and the distance from the axis 13.

As such, stress concentration may be prevented by reducing the disposition density of the plurality of bolts 11 disposed in the projected area of the main pole magnet 6a below the disposition density of the plurality of bolts 11 disposed in the projected area of the interpole magnet 6b.

When a cooling passage allowing a cooling medium to flow therethrough is provided inside or on a surface of the housing 5, the plurality of bolts 11 disposed in the projected area of the main pole magnet 6a are disposed at positions that avoid the cooling passage.

In the second embodiment, when the housing 5 deforms due to an inertial force and stress is generated in the mover 2, a plurality of bolts 11 are disposed at locations of reduced deformation of the mover 2, and fewer bolts 11 are disposed at locations of larger deformation. Thus, stress generated around the bolts 11 is not concentrated near the main pole magnet 6a and separation of the magnet 6 is prevented.

### Third Embodiment

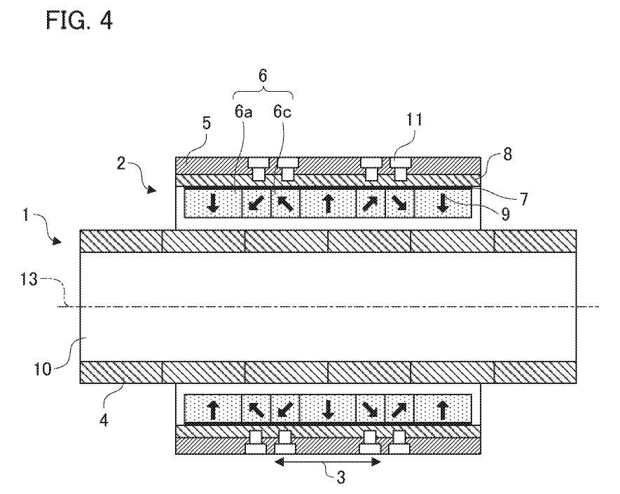

FIG. 4 is a view showing an example of a configuration of the electromagnetic actuator according to the third embodiment. The mover 2 according to the third embodiment is constituted of the main pole magnet 6a magnetized in a direction orthogonal to the axis, and an interpole magnet (oblique pole) 6c whose magnetization direction is tilted in the axial direction with respect to the main pole magnet 6a.

In the present embodiment, a Halbach array is formed in which the interpole magnets (oblique poles) 6c are disposed between the main pole magnets 6a, and two interpole magnets (oblique poles) 6c whose magnetic pole orientations are inverted with respect to each other in an axially symmetrical manner are disposed between the main pole magnets 6a.

Accordingly, an electromagnetic actuator capable of outputting a higher thrust is realized. In addition, in the case of a Halbach array, the number of interpole magnets with more precisely designated magnetic pole directions may be increased.

Similar to the first embodiment, the bolts 11 employed for fastening the housing 5 and the yoke 8 are disposed in the projected areas of the interpole magnets (oblique poles) 6c and are not disposed in the projected areas of the main pole magnets 6a, which is more likely to separate from the adhesive layer 7.

However, as in the second embodiment, the number of bolts 11 disposed in the projected areas of the main pole magnets 6a may be set to be less than the number of bolts 11 disposed in the projected areas of the interpole magnets 6c.

### Fourth Embodiment

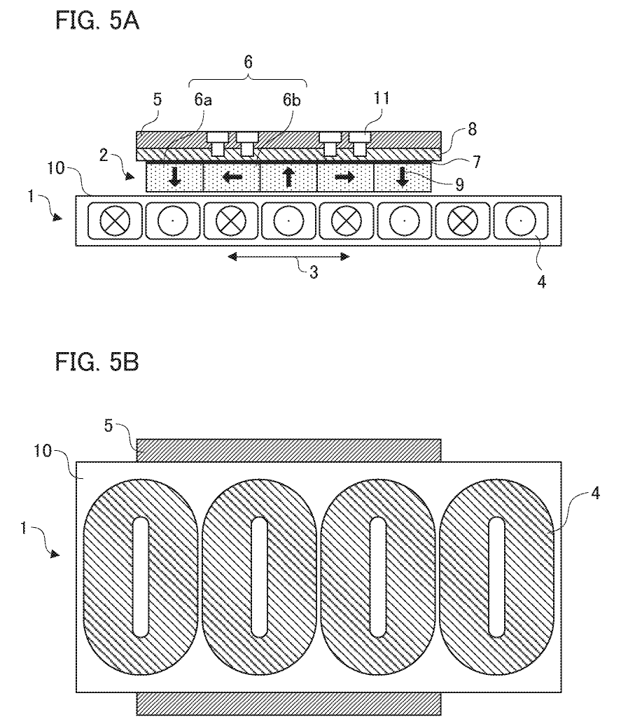

FIGS. 5A and 5B are views showing another example of a configuration of the electromagnetic actuator according to the fourth embodiment. FIG. 5A is a cross-sectional view showing an example of a configuration along a plane including the axis 13, and FIG. 5B is a view showing an example of a configuration viewed from below the stator in the direction of the housing 5.

The stator 1 according to the fourth embodiment has the support member 10 and a plurality of coils 4. For example, as shown in FIGS. 5A and 5B, the coils 4 are disposed such that a part thereof in the winding direction is oriented in the first direction 3, and the direction of the magnetic pole generated by the coils 4 is orthogonal to the first direction 3. In the mover 2, the magnets 6 are disposed on the inner surface.

Here, similar to the first to third embodiments, the main pole magnet 6a and the interpole magnet 6b are arranged in a Halbach array, and the bolts 11 for fastening the housing 5 and the yoke 8 are also disposed in the projected area of the interpole magnet 6b, similar to the first to third embodiments, without being disposed in the projected area of the main pole magnet 6a, which is more likely to separate from the adhesive layer 7.

As in the second embodiments, the number of bolts 11 disposed in the projected area of the main pole magnet 6a may be set to be less than the number of bolts 11 disposed in the projected area of the interpole magnet 6b.

The fourth embodiment has a simpler structure than the first embodiment. Accordingly, the occupying area reduced, manufacture is more readily facilitated, and cost is reduced.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions. For example, an electromagnetic actuator in which a fixed magnet having a rectangular cross-sectional shape, for example, is used as a stator and a movable coil surrounding the fixed magnet is used as a mover may be used.

In addition, as described above, the electromagnetic actuator using a fixed coil and a movable magnet having a circular or elliptical cross-sectional shape may be adopted, and the cross-sectional shapes and the configurations of the stator 1 and the mover 2 may be changed as appropriate.

This application claims the benefit of Japanese Patent Application No. 2025-028186, filed on February 25, 2025, which is hereby incorporated by reference herein in its entirety.

What is claimed is:

1. An electromagnetic actuator comprising:
a stator extending in a first direction; and
a mover configured to move in the first direction,
wherein the mover includes a yoke, a housing, a main pole magnet and an interpole magnet,
the main pole magnet is configured to orient a magnetic pole in a direction perpendicular to the yoke,
the interpole magnet is configured to orient a magnetic pole in a direction not perpendicular to the yoke,
the main pole magnet and the interpole magnet are fixed to the yoke with an adhesive,
the yoke and the housing are fastened using a plurality of bolts,
a first group of bolts of the plurality of bolts is provided on a projected area of the main pole magnet,
a second group of bolts of the plurality of bolts is provided on a projected area of the interpole magnet, and
the first group includes fewer bolts than the second group.

2. The electromagnetic actuator according to claim 1,
wherein at least one of the stator and the mover has a cooling passage.

3. The electromagnetic actuator according to claim 1,
wherein the stator has at least one coil, and a support member.

4. The electromagnetic actuator according to claim 1,
wherein the mover has a hollow surrounding an outer circumferential portion of the stator in a plane orthogonal to the first direction, and two pairs of opposing magnets are arranged on an inner surface of the mover.

5. The electromagnetic actuator according to claim 1,
wherein the plurality of bolts are not disposed in the projected area of the main pole magnet.

6. The electromagnetic actuator according to claim 1,
wherein spacings between bolts of the plurality of bolts on the projected area of the main pole magnet are wider than spacings between bolts of the plurality of bolts in the projected area of the interpole magnet.

7. The electromagnetic actuator according to claim 1,
wherein spacings between bolts of the plurality of bolts on an end portion of the mover in the projected area of the main pole magnet are wider than spacings between remaining bolts of the plurality of bolts.

8. The electromagnetic actuator according to claim 1,
wherein a number of the bolts in the projected area of the main pole magnet disposed at an end portion of the mover is less than a number of the bolts in the projected area of the interpole magnet disposed at locations other than the end portion of the mover.

9. An electromagnetic actuator comprising:
a stator extending in a longitudinal direction; and
a mover configured to move in the longitudinal direction, wherein:
the mover includes a yoke, a housing, a main pole magnet and an interpole magnet,
a plurality of bolts that fasten the yoke and the housing are divided in a first group and a second group,
the first group is provided on a projected area of the main pole magnet,
the second group is provided on a projected area of the interpole magnet, and
the second group includes a greater number of bolts than the first group.

10. The electromagnetic actuator according to claim 9, wherein:
the main pole magnet is configured to orient a magnetic pole thereof perpendicular to the longitudinal direction, and
the interpole magnet is configured to orient a magnetic pole thereof in a direction not perpendicular to the longitudinal direction.

11. The electromagnetic actuator according to claim 9, wherein the yoke extends in the longitudinal direction.

12. The electromagnetic actuator according to claim 9, further comprising an adhesive configured to fix the yoke to at least one of the main pole magnet or the interpole magnet.

13. The electromagnetic actuator according to claim 9, further comprising a cooling passage provided in at least one of the stator or the mover.
